(19) United States
(12) Patent Application Publication
(10) Pub. No.: US 2004/0145352 A1
(43) Pub. Date: Jul. 29, 2004

(54) Method and apparatus for providing temperature-regulated battery charging

(76) Inventor: Chris Harrison, Mount Kisco, NY (US)

Correspondence Address: BAKER & BOTTS, 30 ROCKEFELLER PLAZA, NEW YORK, NY, 10112

(21) Appl. No.: 10/752,977

(22) Filed: Jan. 7, 2004

Related U.S. Application Data
(60) Provisional application No. 60/438,590, filed on Jan. 7, 2003.

(51) Int. Cl. H02J 7/16

(52) U.S. Cl. 320/150

(57) ABSTRACT

A processor controlled charging platform/arrangement, and process using responsive charging of a battery as a function of internal resistance and environmental conditions of the battery are provided. Both voltage and temperature measurements can be used to determine the particular chemical state of a battery. Voltage data can be obtained by taking measurements across the battery terminals during the charge, and such data can be used to determine when charging is complete. Temperature data may also be obtained using thermal sensors placed on the surface or terminals of the battery, or utilizing sensors integrated into the battery. The charging platform/arrangement and process use a high current charge while the internal resistance of the battery is low, thus producing moderate heat, then self-adjusting to a lower intensity charge as internal resistance increases, so as to minimize the heat produced. As a result, the battery temperature can be kept at the battery's temperature limit, while maximizing the charging current.

### CROSS-REFERENCE TO RELATED APPLICATION

The present application claims priority under 35 U.S.C. § 119(e) from U.S. Patent Application Serial No. 60/438,590, filed on Jan. 7, 2003, the entire disclosure of which is incorporated herein by reference.

### FIELD OF THE INVENTION

The present invention relates to temperature-regulated battery charging. In particular, the present invention relates to a method and apparatus provided for adjusting a charge intensity based on an internal resistance expression of the battery that can be expressed through internal heat generation.

### BACKGROUND OF THE INVENTION

When batteries are first manufactured, their chemical states and characteristics are generally similar, but not uniform. However, as batteries are used for various applications with different workloads, environmental conditions and user care, the chemical characteristics of such batteries change. Many conventional battery charging methods assume battery uniformity and therefore do not provide an optimal charge since methods for charging a battery can affect, inter alia, battery life, performance, efficiency, and charging time. It is known that exposure to extreme temperatures is one of the main causes of a chemical degradation in batteries. For example, in nickel metal hydride batteries (NiMH), temperatures of 50° C. may cause the battery to vent alkaline electrolyte, thus severely reducing battery performance and posing a safety hazard. For example, some NiMH batteries manufactured by Panasonic may be damaged at temperatures of 40° C. If a charger is well designed and responsive to the particular batteries chemical state a quick and safe charge may be delivered to the battery while minimizing these detrimental factors.

Many battery chargers have been previously provided that use a constant current or a constant voltage while charging the battery. However, the constant current charge methods generally do not use battery feedback, and likely assume battery homogeneity. Constant voltage charging provides some battery-specific feedback, and the increase in voltage during the charge can provide important information about the chemical state of the individual battery. Nevertheless, conventional battery charging techniques do not use this information effectively. The voltage data is typically ignored, and the current is scaled only in response to the increase in the battery's terminal voltage. For example, during the initial stages of charging a depleted battery, the cell in the battery can accept a very high charging current, however, constant current or constant voltage charging procedures do not take advantage of this characteristic. Furthermore, constant current or constant voltage charging is not sensitive to environmental variables (e.g. an enhanced heat diffusion), which would allow a more intense current to complete the charge in a faster time period. Conversely, under certain low heat diffusion conditions, e.g. hot conditions, a non-temperature-regulated charger may overheat the battery and likely reduce the capacity and functional life-span of the battery.

In the past, battery chargers have incorporated temperature sensors in the charging apparatus so as to allow a particular charging response if the battery reaches a predetermined temperature. In one example, the conventional charger reduces or pauses the charge for a set period of time to allow the battery to cool, then resumes the charge. This method can be time consuming since during these pauses, the battery receives no charge. In another example, the charger simply terminates the charge when a specified temperature is reached, leaving an incompletely charged battery. Other methods complete the charging of the battery by switching such charging to a trickle charge. However, this method takes a significant amount of time to complete. None of these conventional methods or devices use the temperature data to scale the intensity of the charge, but instead use the measurement of battery temperature only as a safety device.

### OBJECTS OF THE INVENTION

One of the exemplary objects of the present invention is to provide a responsive charger that adjusts the charge intensity based on information obtained from the battery via sensors. A temperature-based solution has the advantage that a very high charging current can initially be employed, assuming the battery is charged under average environmental conditions. If the battery temperature remains constant, the charger would likely continue providing a high charging current. If the temperature rises, the charger can respond by reducing the current to the battery. Conversely, a detected temperature drop may cause an increase in the current to the battery. In this manner, a temperature threshold can be preserved, while maintaining the maximum possible charging current to the battery by establishing a equilibrium between heat generation in the battery and heat diffusion. Accordingly, not only is the battery charged safely by keeping its temperature under or at a maximum threshold, but the battery can also be completely charged in a shorter amount of time.

### SUMMARY OF THE INVENTION

The present invention relates to temperature regulated battery charging. In particular, the present invention relates to a method and apparatus provided for adjusting a charge intensity based on an internal resistance expression of the battery that can be expressed primarily through heat generation.

According to one exemplary embodiment of the present invention, the characteristics of the battery are quantified, and the charging intensity is continually adjusted to deliver the maximum charging current without exceeding a predetermined temperature threshold.

According to another exemplary embodiment of the present invention, a self modifying charging platform can be implemented that incorporates the charging procedure into a processor, e.g., a microprocessor, microcontroller, etc., that receives and transmits data to a charging device. The charging device may use such data, e.g., for determining the maximum current to the battery. In a further embodiment of the present invention, the self-adjusting charging platform can respond to changes in internal resistance via temperature data from sensors and calculates the necessary charging intensity in order to maintain the battery temperature at or below a predetermined level. In still another exemplary embodiment of the present invention, a temperature sensor may be mounted on the battery, e.g., pressed against the skin of the battery when holstered in the charger, or contained within the battery, to relay temperature data to the processor. The temperature data may be used to produce an intended charge current. In a further embodiment, the charging procedure may utilize temperature, change in temperature, or voltage data. In still a further embodiment, a processor may determine the charge current value necessary to maintain a battery temperature threshold. This charge current value may then be output to set the actual charging current transmitted to the battery. In another exemplary embodiment, a nickel metal hydride battery, a nickel cadmium battery, a lead acid battery or a lithium ion battery can be charged with the methods of the present invention.

### BRIEF DESCRIPTION OF THE DRAWINGS

For a more complete understanding of the present invention and its advantages, reference is now made to the following description, taken in conjunction with the accompanying drawings, in which:

FIG. 1 is an exemplary graph showing two distinctive temperature phases during constant current charging of a NiMH battery;

FIG. 2 is an exemplary graph showing a change in temperature of a NiMH battery as a function of time during charging, illustrating an ideal situation according to the present invention;

FIG. 3 is a block diagram of an exemplary battery charging platform according to the present invention;

FIG. 4 is a block diagram of an exemplary battery charging platform according to the present invention;

FIG. 5A is an exemplary graph showing a temperature measurement at four points on the battery during charging and a control measurement at ambient temperature;

FIG. 5B is an enlarged portion of the exemplary graph of FIG. 5A showing the temperature measurement during a charge termination;

FIG. 6 are exemplary graphs showing the charging current as a function of battery temperature using exemplary control functions according to the present invention; and

FIG. 7 shows a flow diagram of an exemplary embodiment of a method according to the present invention.

### DETAILED DESCRIPTION

Charging method and apparatus according to exemplary embodiments of the present invention are described herein below with reference to the accompanying drawings.

A. Exemplary Embodiments of the Present Invention

According to a first exemplary embodiment of the present invention, a charging platform that includes a processor, e.g., a microcontroller, may be used to control the charging of a battery as a function of battery temperature. In one exemplary embodiment, both voltage and temperature measurements can be used to determine a particular chemical state of the battery. Voltage data can be obtained by taking measurements across the battery terminals during the charging, which may then be used to determine when, e.g., a NiMH battery is completely charged. From such data, differences in individual cells may be determined and used to control the charge intensity for a particular battery. In another exemplary embodiment, the temperature data may be obtained using thermal sensors placed on the skin (surface) or terminals of the batteries. The heat generated during a charge, e.g., due to a hydrogen absorption in the battery, can vary during the charging as a result of changes in the internal chemistry of the battery. Therefore, the measured battery temperature can be directly related to the internal resistance of the battery.

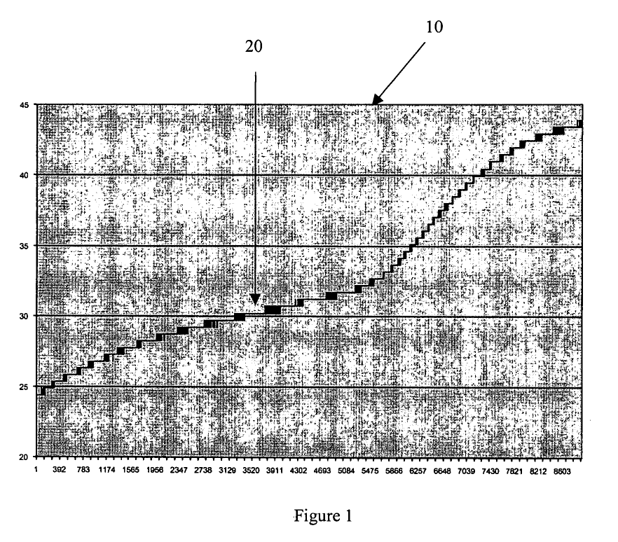

In one example, a 6500 mAh, NiMH D-cell battery manufactured by Panasonic was charged according to one embodiment of the present invention. Referring to FIG. 1, two distinctive phases are generally present during the battery charging for several chemistries, representing two distinct levels in the internal resistance of the battery. During the first phase of the 6.5 A charging, the battery temperature may rise to 32° C. until a transition to the second phase occurs, where the temperature may increase rapidly and approach 44° C. This two-phase temperature characteristic may be used to determine the effectiveness of the charge. According to one exemplary embodiment of the present invention, the second phase may be dampened to avoid a temperature increase above a predetermined level. This dampening ensures that the battery is not overheated, and extends the battery life and performance. In addition, to capitalize on the battery's low internal resistance during the start of the charge, it is possible to use higher intensity charging while temperature generation is low, thus dramatically decreasing the time needed to complete the charge of the battery.

Therefore, it would be beneficial if a high intensity charge is used while the internal resistance of the battery is low, and then adjust to a lower intensity charge as internal resistance increases (minimizing the amount of heat produced). As a result, the battery temperature may be maintained at the battery's temperature limit while maximizing the charging current. During the charging, the data may be analyzed by a processor, and the charging current optimized as a function of battery temperature. Using this exemplary method and arrangement according to the present invention, nine exemplary control functions have been provided that allow regulated battery charging, as described below in greater detail.

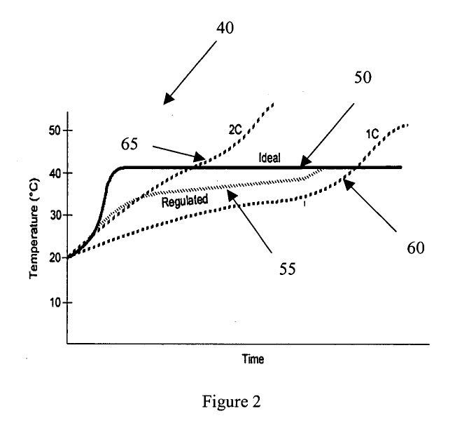

Using a charging arrangement/platform and, a regulated charging using 1C and 2C charges can be performed (where C is a capacity rating). For example, if the battery manufacturer rates a NiMH D cell at 6500 mA capacity, the 1C charge is 6.5 A constant current charge. As shown in FIG. 2, a 1C charge has generally a slow temperature elevation throughout the charge until close to charge termination. If the charge was to continue to be unregulated, the battery would likely reach a temperature of about 45° C. at the end of the charge, which is above the recommended maximum temperature for the batteries used. If the charging is terminated at 40° C. due to a temperature safety mechanism, as described above, the batteries would likely not be fully charged. A 2C charge also has a temperature elevation throughout the charge until near termination. Using this charge current, the temperature would likely increase to about 50° C. if unregulated, which would result in damage to the battery.

The curve 55 in FIG. 2 labeled “regulated” provides the results using one embodiment of an arrangement and platform according to the present invention. A polynomial function may be used to determine the maximum charge current for a measured battery temperature. This determination allows the battery to be charged at a significantly higher temperature during approximately the initial 80% period of charging in comparison to a comparable constant current or voltage charge. During the second phase, when there is a high internal resistance in the battery, the battery temperature begins to rise rapidly and the charging current is therefore reduced in response. As long as the temperature in the battery continues to rise, the charging current would likely fall until an equilibrium is reached (e.g., based on feedback characteristics of the battery). The result of such procedure is a dampening of the rapid heating during the second phase, thus maintaining the battery temperature at or below a specified temperature during most of the charge. Furthermore, the battery's temperature limit will not be exceeded during the course of the charge or at the charge termination. FIG. 2 also shows an exemplary “ideal” curve 50 providing the ideal maintenance of battery temperature at a specified threshold, while delivering the maximum charge. Oscillations would likely be present (not shown in the graph) due to thermal lag time, but the temperature threshold would likely be maintained by, e.g., no more than about a ±2° C. difference. In one exemplary embodiment of the present invention, a warm-up period may be used to rapidly charge/heat the battery to the threshold and then switch to a regulation mode, where the charge may be controlled as described above.

In a further embodiment, termination of the charge may be determined by the voltage measured across the terminals of the battery. In one example, the charge may end when the battery reaches a predetermined voltage value, e.g., 1.5V. In another example, a negative change in voltage (i.e., negative ΔV) may be used to determine when charging of the battery is complete. For instance, in some chemistries, most notably NiMH batteries, the voltage starts decreasing when 100% charging capacity is reached. Therefore, if the voltage drops consistently charging terminates. In a further example, since some battery chemistries may cause a slow approach to a charged voltage, when the increase in voltage during charging slows the charge is complete. Accordingly, if the rate of the change in voltage drops below a predetermined tolerance, the charge terminates.

B. Implementation of an Exemplary Embodiment of a Charging Platform/Arrangement

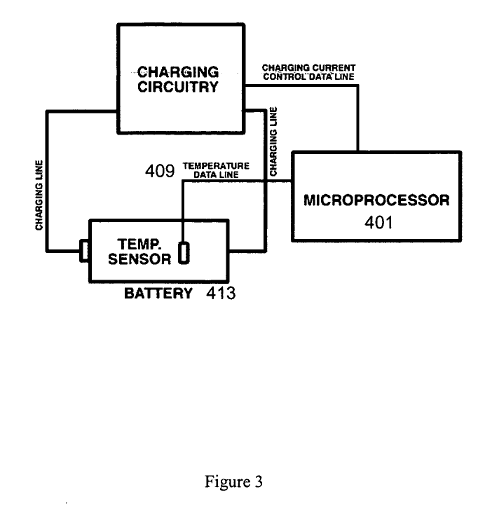

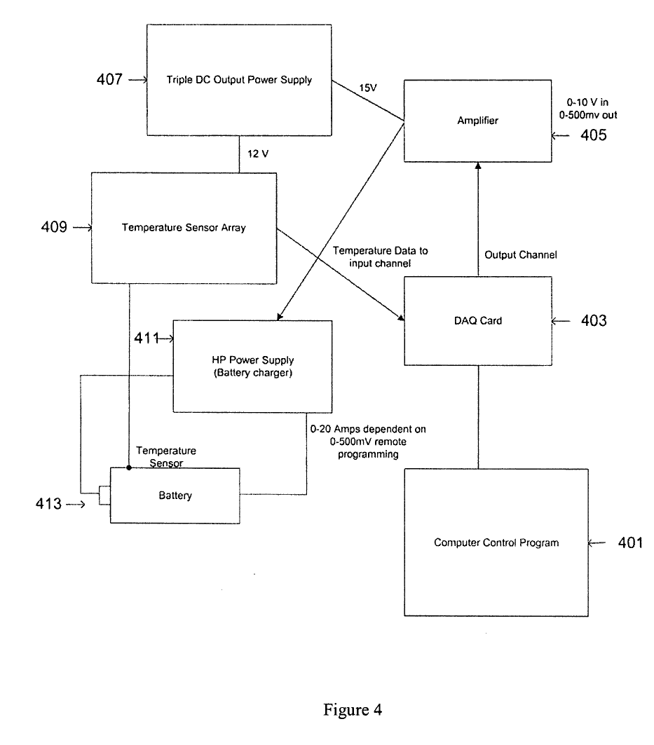

An exemplary charging platform according the present invention is shown in FIGS. 3 and 4. Referring to FIG. 4, the charging platform includes five temperature sensors 409 and utilizes potentiometers to calibrate each sensor to equivalent levels, e.g., a LM335 device can be used as the base for each sensor. The LM335 output voltage is the temperature in Kelvin, i.e., 1 mV=1 degree K. A “divide by 20” amplifier 405 may be used to convert the 0-10V range on a DAQ card 403, which may also have two 0-10V analog output channels that may used to control the charging, e.g., in the 0-500 mV range, with a power supply 411 (e.g., Hewlett Packard HP6264B). Thus, in one exemplary embodiment of the present invention, a computer control program 401 will vary the voltage from the DAQ card 403 in response the temperature sensor measurements, and the power supply 411 may respond by outputting between no current to a maximum current, e.g., 20 A, to the battery 413.

In a further embodiment of the present invention, an output on a second power supply 407 (e.g., TP430A providing 0-32V 0-2.5 A) may be used to simulate the DAQ card 403 analog output channel (0-10V). The current from such second power supply may then be passed through the amplifier 405 to scale the voltage (e.g., to 0-0.5V). The amplifier 405 can then be connected to remote control terminals on the first power supply 411. To acquire scaling procedure parameters, the power supply 411 can be tested from 0V to 10V in 0.5V increments, and plotted with the current data from a shunt. A cubic regression is preferable with R²=0.998. This exemplary scaling procedure may then be used to convert the desired amperage to a compensated voltage value that may be forwarded to an analog output channel on the DAQ card 403. Noise, wire resistance, etc., that cause values to differ slightly than the predicted current, may also be taken into account.

C. Implementation of an Exemplary Embodiment of a Method

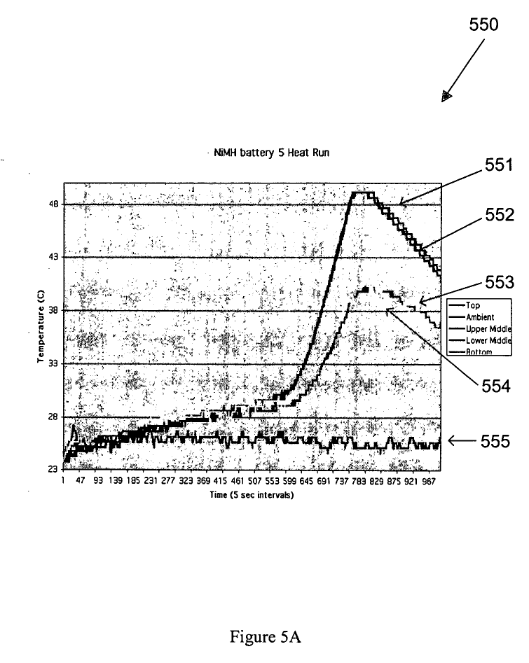

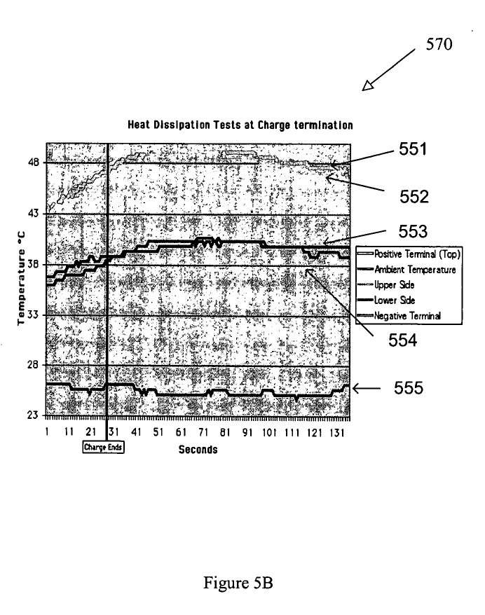

Temperature measurements may be taken at different points on the surface of the battery to locate an area on the battery with the least thermal lag time. FIGS. 5A & 5B show graphs 550 and 570 of the temperature of a 6500 mAh, NiMH D-cell battery manufactured by Panasonic at the lower middle 551, the upper middle 552, the bottom 553 and the top 554 of the battery. Also shown in FIGS. 5A and 5B is the ambient temperature 555 during charging. As shown in the figures, during charging according to the present invention both the lower side and bottom side of the battery (e.g., a negative terminal of the battery) have the quickest drop in temperature. Accordingly, a procedure for temperature-regulated charging according to the present invention may be implemented using the data from these areas to more accurately assess the chemical state of the battery.

In one example, a 6500 mAh, NiMH D-cell battery manufactured by Panasonic was charged according to control functions of the present invention as described below. One skilled in the art with the benefit of this disclosure would realize that these control functions may be utilized with other battery systems and/or battery chemistries to attain the objects, features and advantages of the present invention.

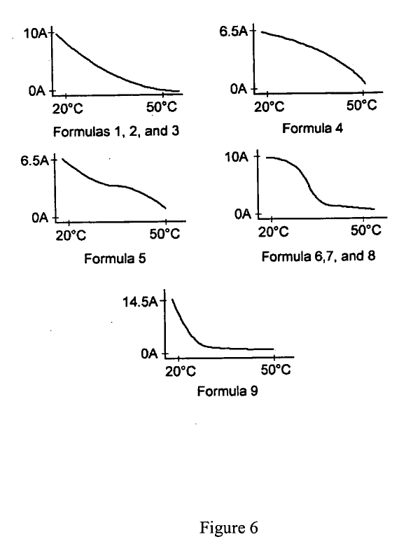

In one exemplary implementation of the charging procedure according to the present invention, an initial 10 amp current may be used to charge the battery. As shown in the graphs of FIG. 6, control functions represented by formulas 1, 2 and 3 provided as follows:

0.0056x²−0.7502x+24.0824 (1);

0.0076x²−0.9561x+30.0095 (2);

0.0110x²−1.2154x+33.9590 (3)

may be used to control charging intensity based on temperature data collected from the sensors, but may overheat the battery at mid-temperatures during the transition to the second phase (27-32° C.). Since the preferred charging current may be 6.5 A for a 1C battery, the batteries may be charged at this initial current, under average environmental conditions, using exemplary formulas 4 and 5, as follows:

0.0001x³−0.0175x²+0.3954x+4.8879 (4);

−0.000011x⁴+0.00l9x³−0.1116x²+2.529x−11.994 (5)

During the temperature rise of the second phase, the current drop can be effective to compensate for the rise in the battery temperature. Formula (5) may be used as a phase-mirroring style in the apparatus according to the present invention. Since the battery expresses two phases as it shifts between the two temperatures expressions, formula (5) can include two expressions that correspond to each phase of the battery so that the two phases may be responded to with a more specific control function. During the first phase, the battery can accept the higher current freely. As the transition to the second phase begins, the temperature may suddenly increase, and the process likely immediately decreases the current. However, because the first phase has a low internal resistance, the battery can accept higher charge rates, which may be used to reduce the overall charging time. Therefore, to optimize charging, an initial charging current of 10 A may be used. However, a much higher charging current may also be used to further decrease charging time.

In another exemplary embodiment, the values used to control the current during charging may be further optimized as provided in formulas 6-8, as follows:

−0.000012x⁴+0.00314x³−0.1648x²+2.957x−3.1455 (6);

−0.0000118x⁴+0.00213x³−0.1321x²+3.0879x−15.8181 (7);

−0.0000114x⁴+0.00175x³−0.08672x²+1.2630x+6.3787 (8)

In still another embodiment of the present invention, a procedure used with a particular formula may be implemented (e.g., formula 9, −0.000225x⁴+0.9287x³−1.298x²+24.06x−140.704), which includes similar concepts as provided in the above described formulas. For example, the battery can be initially charged with a current of 14.5 A through the first phase, assuming average environmental conditions. With such intense initial charging, the battery becomes hotter than with other charging during the start of the first phase, as shown in FIG. 6. A quick drop in charge may be a sufficient response to changes in temperature, and can compensate for the shift to the second phase much more effectively. The result is a charge that returns more amp hours faster in comparison to the usage of other exemplary formulas due to charging at a current that is more readily absorbed by the battery. Using the charging procedure of formula 9 according to the present invention, the battery temperature may be maintained under 33° C., using Panasonic 6500 mAh, NiMH D-Cell Batteries, while decreasing the time to charge the battery. As a result, the discharge runs conducted on these batteries may have an enhanced capacity and performance when compared to batteries charged using constant current or constant voltage. In no way should such exemplary control formulas be read to limit the scope of the invention. One skilled in the art with the benefit of this disclosure would realize that these control functions may be optimized or other control functions utilized to attain the objects, features and advantages of the present invention.

To determine whether the temperature-regulated charges are effective, standard charges can be conducted for comparison purposes. Standard charges may include the Panasonic recommended rapid constant current charge (6.5 A), a 9 A constant current charge and a 12 A constant current charge. Applying these constant current charges, the first phase can slowly and steadily increase to around 30-33° C., using Panasonic 6500 mAh, NiMH D-Cell Batteries under typical environmental conditions, without forming a plateau. Therefore, the charge is too intense to allow the temperature to be maintained through heat dissipation. The batteries tested can have an average temperature during charging that is 8° C. hotter for the 6.5 A charge, about 5° C. hotter for the 9 A charge, and about 3.5° C. hotter for the 12 A charge. This result is likely due to the negative ΔV effect expressed by the battery used to terminate the charge. Examining the temperature after charge termination, the battery charged at 12 A generally increases in temperature by about 2° C. due to the increased core temperature, as compared to the external temperature. In contrast, the battery charged at 6.5 A only increases about 1° C. after charge termination. This indicates that core temperatures using higher charge currents are hotter than when using lower intensity charges, thus resulting in continued heat diffusion for longer periods of time.

With the addition of a fan to cool the battery during the charge, average charging time can be reduced by half (e.g., with the implementation of formula 9 with a fan as opposed to formula 9 without a fan). This is because the charger can apply a more intense current throughout the charge due to the increased heat diffusion. Therefore, this exemplary embodiment of the apparatus according to the present invention may be used with any method to lower the surface temperature of the battery, and allow for an increased charge intensity, e.g., a fan, circulated water, etc. As a result of the reduction of the second phase's rapid heating, the stress on the internal materials of the battery may be reduced, thus resulting in an increase in the cycle life of the battery.

The exemplary charging method of the present invention may also be environmentally sensitive. For example, conventional charging systems generally rely on a predetermined heat diffusion to ensure that the battery does not overheat. However, if charging occurs in, e.g., a particularly hot environment, heat diffusion would decrease, and may cause the battery to overheat or terminate the charge prematurely. The temperature-regulated charging platform and method of the present invention can charge the battery without exceeding its limits by using a lower charging current, while still charging the battery relatively quickly. Conversely, charging in, e.g., a colder climate, where the environment diffuses heat from the battery readily, a conventional charger would still perform its normal charge. However, the exemplary temperature regulated charging methods of the present invention take advantage of the increased heat diffusion, and can apply a higher intensity charge to obtain the charge of the battery at a much quicker rate.

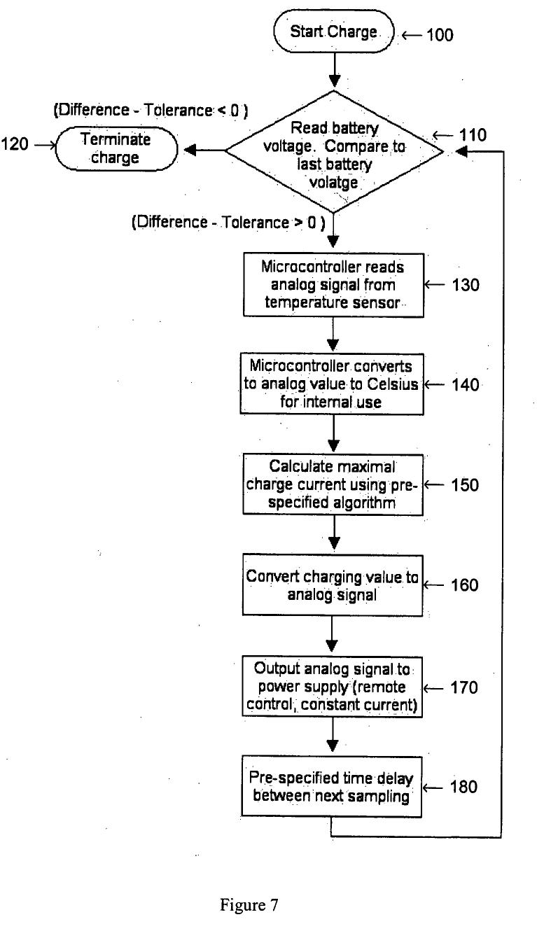

FIG. 7 shows a flow diagram of exemplary steps executed by a computer control program of the platform/arrangement according to the present invention. After charging is initiated in step 100, the battery voltage is measured and compared to the last measured battery voltage in step 110. If the difference between the measured voltages is less than predetermined threshold (e.g., zero), taking into account the tolerance of the system, the battery may be fully charged, and the charging is complete and terminated in step 120. In one exemplary embodiment, if the difference between the measured voltages is more than the predetermined threshold, taking into account the tolerance of the system, the battery may not be fully charged and the microcontroller can determine the analog temperature value from the temperature sensor in step 130. The microcontroller can then convert the analog temperature value to Celsius for internal use in step 140. Based on this temperature value, the maximum charge current value can be determined using a specified procedure/control function. This charge current value may be converted to an analog signal in step 160, and the signal is output to the power supply in step 170, which then regulates the charge transmitted to the battery. After a specified time delay in step 180, the battery voltage is again measured in step 110, and the process is repeated until battery charging is complete.

It is to be understood that while the invention has been described in conjunction with the detailed description hereof, the foregoing description is intended to illustrate and not limit the scope of the invention.

What is claimed is:

1. A battery charger configured to provide temperature-regulated charging of a battery, comprising:
a processing arrangement operable to:
(a) obtain a temperature data associated with the battery; and
(b) apply a charge to the battery, the charge being determined based on the temperature data of the battery wherein the battery is maintained at a predetermined threshold temperature.

2. The battery charger according to claim 1, further comprising a processing arrangement operable to:
(c) obtain a voltage data associated with the battery; and
(d) apply a charge to the battery, the charge being determined based on the voltage data of the battery.

3. The battery charger according to claim 1, wherein the charge is applied to the battery until charging of the battery is substantially completed.

4. The battery charger according to claim 1, further comprising the step of using a voltage of the battery to determine if charging of the battery is substantially complete.

5. The battery charger according to claim 1, further comprising the steps of:
(c) measuring a first voltage across a terminal of the battery;
(d) measuring a second voltage across the terminals of the battery after step (c);
(e) determining a difference between the first voltage and the second voltage; and
(f) repeating steps (c)-(e) until charging of the battery is substantially complete.

6. The battery charger according to claim 1, further comprising at least one temperature sensor mounted on or in the battery, wherein the temperature sensor measures the temperature of the battery.

7. The battery charger according to claim 1, further comprising at least one temperature sensor, wherein the temperature sensor measures an ambient temperature.

8. The battery charger according to claim 1, wherein the charge applied to the battery allows a maximum charge intensity during charging of the battery.

9. The battery charger according to claim 1, wherein the temperature-regulated charging is controlled by a processing arrangement.

10. The battery charger according to claim 9, wherein the processing arrangement includes a microprocessor.

11. The battery charger according to claim 1, wherein the charge applied to the battery is based on one of voltage measurements and temperature measurements of the battery.

12. The battery charger according to claim 1, wherein the charge of the battery is further based on a change in the temperature of the battery.

13. The battery charger according to claim 1, wherein the battery comprises a nickel metal hydride battery, a nickel cadmium battery, a lead acid battery and a lithium ion battery.

14. The battery charger according to claim 1, further comprising the step of cooling the battery using a cooling arrangement.

15. A process for providing temperature-regulated charging of a battery, comprising the steps of:
(a) obtaining a temperature data associated with the battery; and
(b) applying a charge to the battery, the charge being determined based on the temperature data of the battery wherein the battery is maintained at a predetermined threshold temperature.

16. The process according to claim 15, further comprising the steps of:
(c) obtaining a voltage data associated with the battery; and
(d) applying a charge to the battery, the charge being determined based on the voltage data of the battery.

17. The process according to claim 15, wherein the charge is applied to the battery until charging of the battery is substantially completed.

18. The process according to claim 15, further comprising the step of using a voltage of the battery to determine if charging of the battery is substantially complete.

19. The process according to claim 15, further comprising the steps of:
(c) measuring a first voltage across a terminal of the battery;
(d) measuring a second voltage across the terminals of the battery after step (c);
(e) determining a difference between the first voltage and the second voltage; and
(f) repeating steps (c)-(e) until charging of the battery is substantially complete.

20. The process according to claim 15, further comprising at least one temperature sensor mounted on or in the battery, wherein the temperature sensor measures the temperature of the battery.

21. The process according to claim 15, further comprising at least one temperature sensor, wherein the temperature sensor measures an ambient temperature.

22. The process according to claim 15, wherein the charge applied to the battery allows a maximum charge intensity during charging of the battery.

23. The process according to claim 15, wherein the temperature-regulated charging is controlled by a processing arrangement.

24. The process according to claim 23, wherein the processing arrangement includes a microprocessor.

25. The process according to claim 15, wherein the charge applied to the battery is based on one of voltage measurements and temperature measurements of the battery.

26. The process according to claim 15, wherein the charge of the battery is further based on a change in the temperature of the battery.

27. The process according to claim 15, wherein the battery comprises a nickel metal hydride battery, a nickel cadmium battery, a lead acid battery and a lithium ion battery.

28. The process according to claim 15, further comprising the step of cooling the battery using a cooling arrangement.

29. A storage medium for providing temperature-regulated charging of a battery, comprising:
a software arrangement operable to:
(a) obtain a temperature data associated with the battery; and
(b) apply a charge to the battery, the charge being determined based on the temperature data of the battery wherein the battery is maintained at a predetermined threshold temperature.

30. The storage medium according to claim 29, further comprising a software arrangement operable to:
(c) obtain a voltage data associated with the battery; and
(d) apply a charge to the battery, the charge being determined based on the voltage data of the battery.

31. The storage medium according to claim 29, wherein the charge is applied to the battery until charging of the battery is substantially completed.

32. The storage medium according to claim 29, further comprising the step of using a voltage of the battery to determine if charging of the battery is substantially complete.

33. The storage medium according to claim 29, further comprising the steps of:
(c) measuring a first voltage across a terminal of the battery;
(d) measuring a second voltage across the terminals of the battery after step (c);
(e) determining a difference between the first voltage and the second voltage; and
(f) repeating steps (c)-(e) until charging of the battery is substantially complete.

34. The storage medium according to claim 29, further comprising at least one temperature sensor mounted on or in the battery, wherein the temperature sensor measures the temperature of the battery.

35. The storage medium according to claim 29, further comprising at least one temperature sensor, wherein the temperature sensor measures an ambient temperature.

36. The storage medium according to claim 29, wherein the charge applied to the battery allows a maximum charge intensity during charging of the battery.

37. The storage medium according to claim 29, wherein the temperature-regulated charging is controlled by a processing arrangement.

38. The storage medium according to claim 37, wherein the processing arrangement includes a microprocessor.

39. The storage medium according to claim 29, wherein the charge applied to the battery is based on one of voltage measurements and temperature measurements of the battery.

40. The storage medium according to claim 29, wherein the charge of the battery is further based on a change in the temperature of the battery.

41. The storage medium according to claim 29, wherein the battery comprises a nickel metal hydride battery, a nickel cadmium battery, a lead acid battery and a lithium ion battery.

42. The storage medium according to claim 29, further comprising the step of cooling the battery using a cooling arrangement.
